(19) United States
(12) Patent Application Publication
(10) Pub. No.: US 2004/0265108 A1
(43) Pub. Date: Dec. 30, 2004

(54) Push-off attachment for forklift trucks

(76) Inventor: Edward James Richardson, Toronto (CA)

Correspondence Address: Anthony Asquith, #28 - 461 Columbia Street West, Waterloo, ON, N2T 2P5, CA

(21) Appl. No.: 10/869,902

(22) Filed: Jun. 18, 2004

(30) Foreign Application Priority Data
Jun. 19, 2003 (GB) 0314288.2

(51) Int. Cl. B66F 1/00

(52) U.S. Cl. 414/661

(57) ABSTRACT

The push-plate of the attachment is guided on left and right pairs of proximal and distal arms. The proximal arms are pivoted at support pivots to the support plate, and the distal arms are pivoted at distal pivots to the push-plate. The proximal arms are pivoted to the distal arms at knee pivots. All three left pivots are parallel to each other, and all three right pivots are parallel to each other. The left pivots all lie at an angle PA to the right pivots. The angle PA is between 80° and 130°. The arrangement is simple and robust, and enables the push-plate to be guided very solidly, over an accurately-straight line path of the push-plate, with no stresses and strains imposed on the pivots by the geometry of the motion.

This invention relates to an attachment for pushing a load off the forks of a forklift truck.

### BACKGROUND TO THE INVENTION

In a forklift truck, the forks are mounted on a carriage which is powered and guided for up/down movement relative to the truck frame. A mounting-structure of the push-off attachment is secured (preferably for rapid assembly/removal) to a suitable attachment-point on the carriage.

A push-off attachment includes a push-plate, which is the element of the attachment that actually contacts the load. The push-plate generally will be a flat plate that lies in a vertical plane, but other configurations of the push-plate are contemplated in specialised applications. (In forklift trucks, often the carriage is tipped back at a small angle to the true vertical; for the purposes of this specification the term vertical includes that case, and the term horizontal should be construed accordingly also.)

Often, a push-off attachment also has facility for pulling the load onto the forks, in which case the attachment may be termed a push/pull attachment. In a push/pull type of push-off attachment, optionally a means is provided on the push-plate of the attachment for snagging the load, or for snagging a slip-sheet on which the load is resting.

A push-off attachment includes a push-off operator (usually a hydraulic ram) and the attachment includes a guide for guiding the movement of the push-plate outwards, and back, with respect to the mounting-structure of the attachment. A push-off attachment may be configured to push the load off the forks that already exist on the carriage of the truck. Or the attachment may include its own forks, which may replace, or fit over, the existing forks.

It is generally a requirement, in a push-off attachment, that the push-plate thereof be supported and guided for movement along the forks in such manner that the push-plate does not rest on the forks. The designer sees to it that the weight of the attachment is supported by the fact that the mounting-structure is attached to the carriage of the truck, and not by the fact that the push-plate runs along the forks. This is not to say that the push-plate cannot touch the forks at all, but rather that the weight of the attachment is supported from the mounting-structure. (A designer possibly might find it easier to support and guide the push-plate, in its movement along the forks, if the weight of the push-plate could be supported by the forks. But that is generally not possible, given the functional requirements of the forks.)

The attachment as described herein also meets this requirement, that the push-plate does not run along the forks, or along any other horizontally-extending structure of the truck frame or of the carriage, whereby the forks would take the weight of the push-plate; rather, the attachment is so structured as to be self-supporting, in that the push-plate is supported entirely from the mounting-structure, once the mounting-structure has been secured to its attachment point on the truck.

The invention is concerned with guiding the push-plate in a self-supporting manner, using fewer moving parts than conventional push-off attachments, without compromising versatility and convenience of operation, and without compromising structural strength and rigidity.

### THE PRIOR ART

Traditionally, a push-off attachment for pushing a load off the forks of a forklift truck has been based on a scissors-like, accordion-like, or pantograph-like, mechanism. Attention is directed to patent publication U.S. Pat. No. 4,752,179 (1988, Seaberg), which shows an example of a typical conventional push-off attachment.

### GENERAL FEATURES OF THE INVENTION

In the invention, a push-plate of the attachment is carried on an operable extension mechanism, which includes a left set of arms and pivots and a right set of arms and pivots. The left set of pivots are aligned parallel to each other, and similarly the right set of pivots are aligned parallel to each other. The left pivots are set at an angle, which preferably is a right angle, to the angle of the right set of pivots.

### DETAILED DESCRIPTION OF PREFERRED EMBODIMENTS

By way of further explanation of the invention, exemplary embodiments of the invention will now be described with reference to the accompanying drawings, in which:

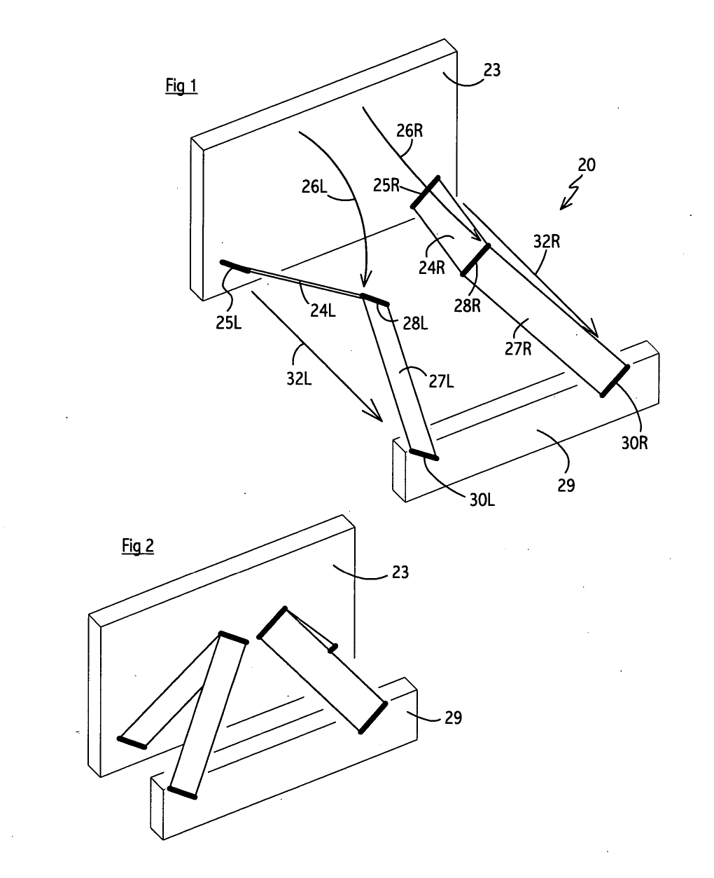

FIG. 1 is a diagrammatic pictorial view of a push-off attachment, showing the disposition of arms and pivots thereon.

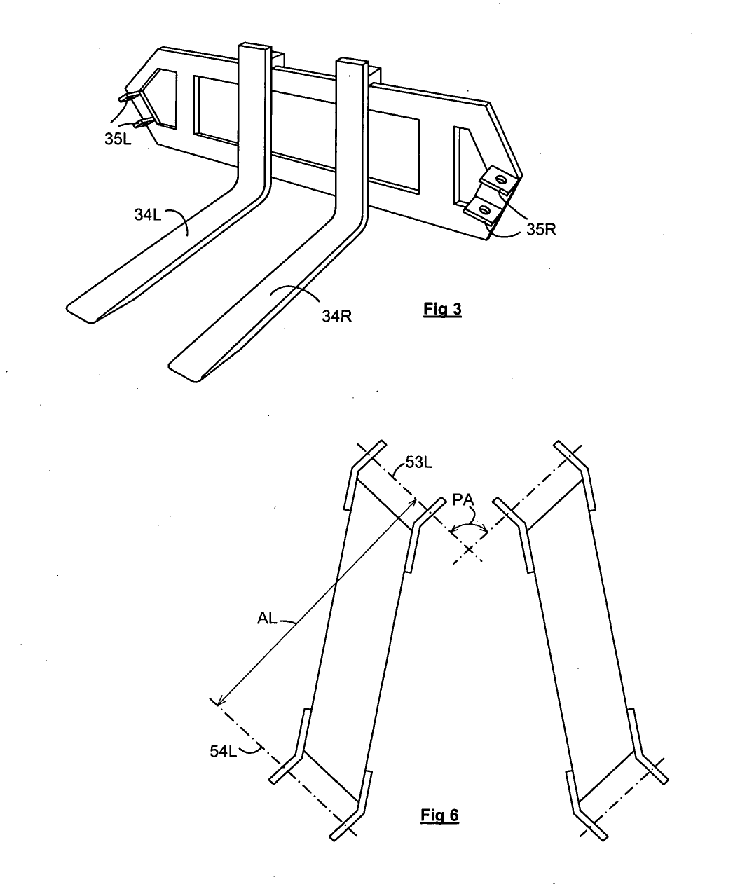

FIG. 2 is the same view as FIG. 1, showing the attachment at a different stage of operation.

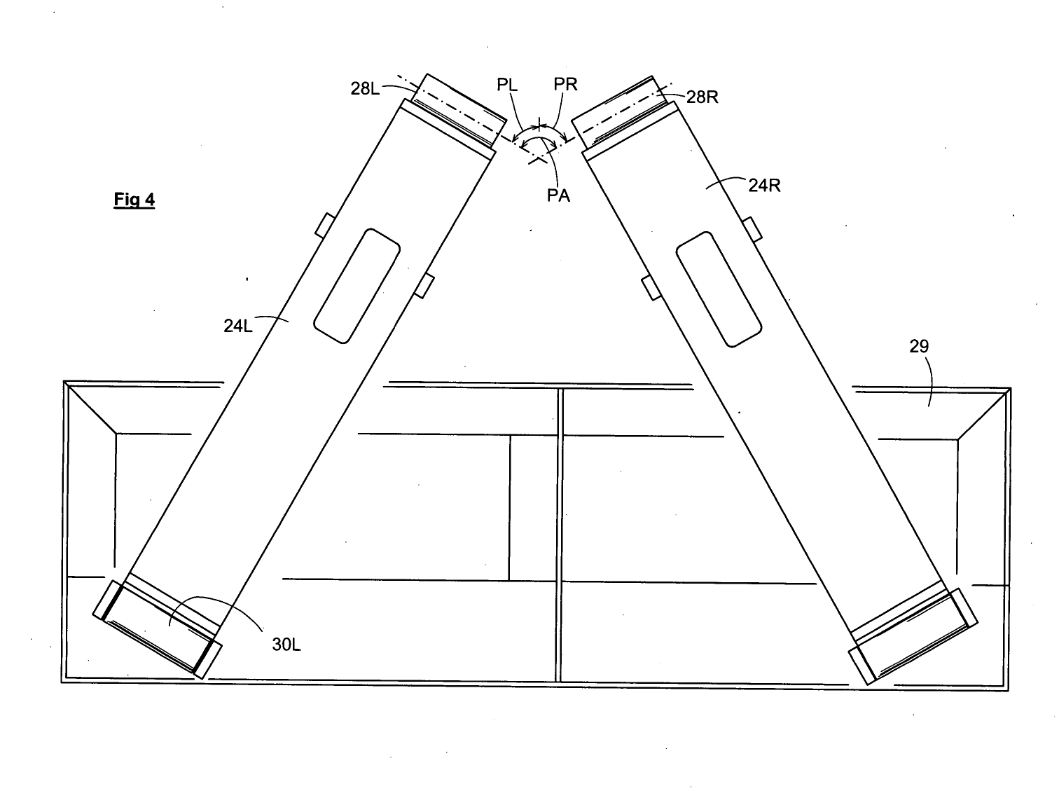

FIG. 3 is a pictorial view of a support-plate component of the attachment.

FIG. 4 is a view from the support-plate towards a push-plate of the attachment.

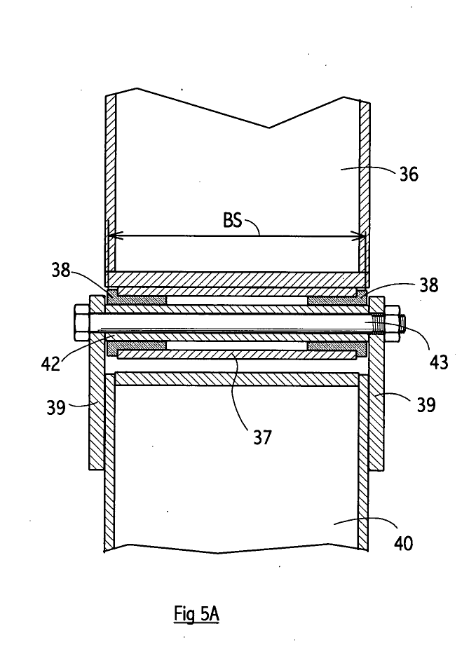

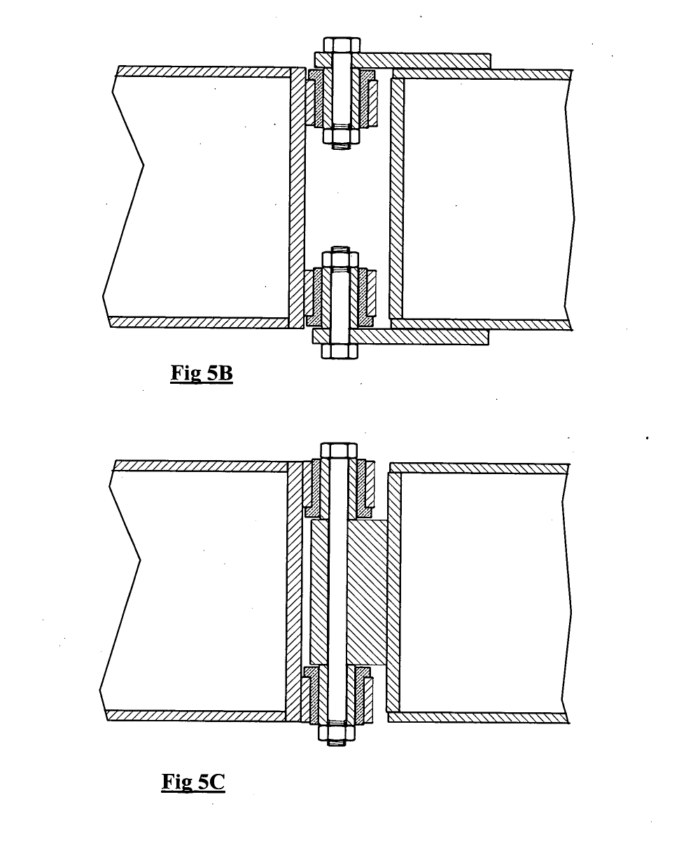

FIG. 5a is a cross-section of a knee-pivot of the attachment.

FIGS. 5b,5c are cross-sections of alternative knee-pivots.

FIG. 6 is a diagram illustrating an alternative manner of arranging the arms of the attachment.

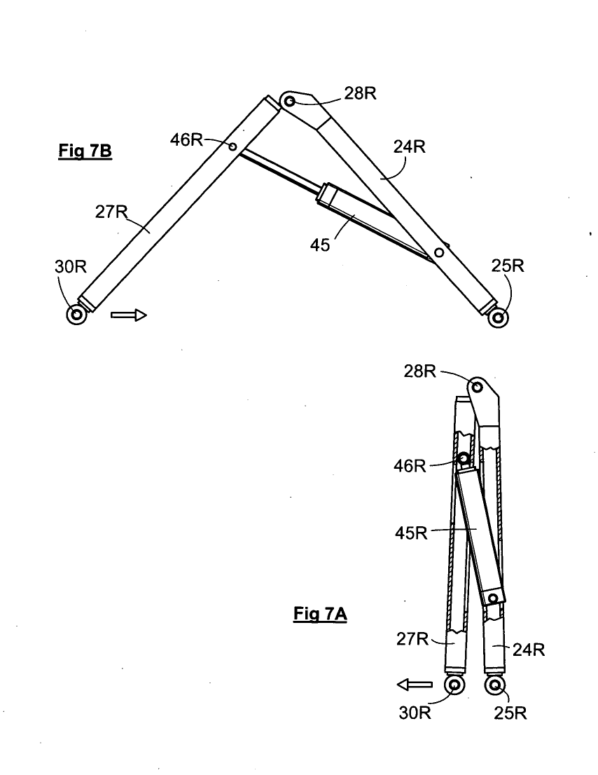

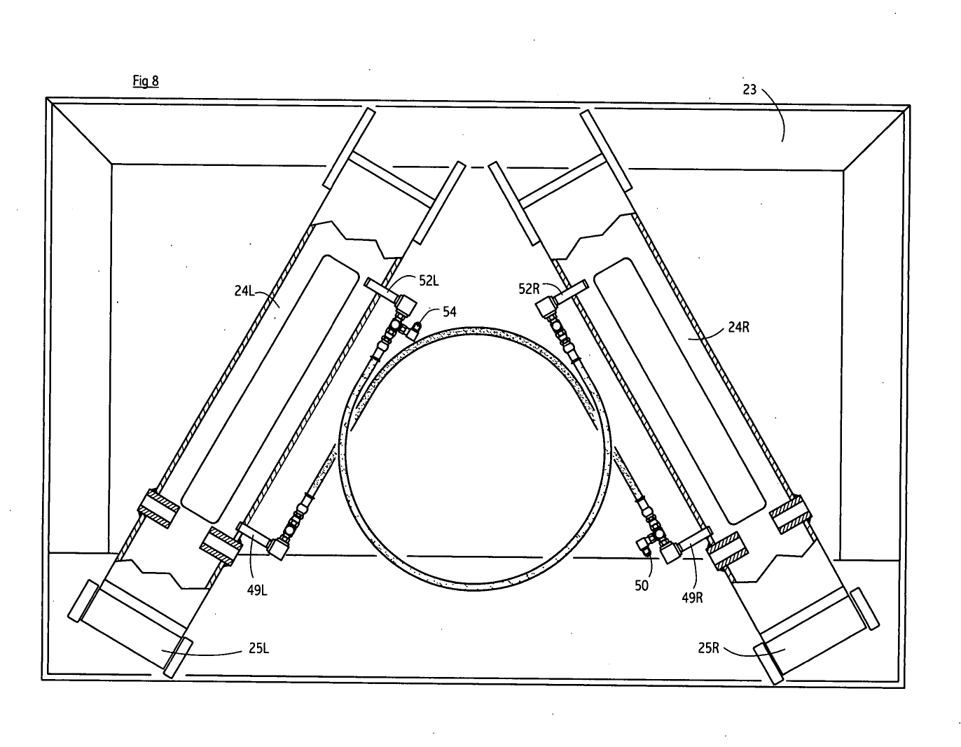

FIG. 7a is a side view illustrating a closed-up position of the arms of an attachment.

FIG. 7b is the same view as FIG. 7a, but shows the arms in an extended position.

FIG. 8 is a view towards the support-plate from the push-plate of the attachment.

The apparatus shown in the accompanying drawings and described below are examples which embody the invention. It should be noted that the scope of the invention is defined by the accompanying claims, and not necessarily by specific features of exemplary embodiments.

FIG. 1 is a diagram of a push-pull attachment 20, showing the manner in which the movable arms and the various pivots are arranged. The attachment is mounted on the carriage of a forklift truck. A support-plate 23 of the attachment may be regarded as unitary with the carriage for operational purposes. FIG. 2 shows the same arrangement at a different condition of extension.

Left and right proximal-arms 24L,24R are hinged to the support-plate 23 at left and right support-pivots 25L,25R. The proximal-arms 24L,24R sweep through arcs 26L,26R centred on the support-pivots 25L,25R.

Carried on the outer ends of the proximal-arms 24L,24R are left and right distal-arms 27L,27R, which are hinged to the proximal-arms 24L,24R at respective knee-pivots 28L,28R. The far ends of the distal-arms 27L,27R are hinged to the push-plate 29 at distal-pivots 30L,30R.

The axes of the left set of pivots 25L,28L,30L are all parallel to each other. The axes of the right set of pivots 25R,28R,30R are all parallel to each other. The two proximal-arms 24L,24R are the same lengths as the two distal-arms 27L,27R. It is not essential that the two left arms 24L,27L be the same length (i.e the same pivot-to-pivot length) as each other, although they are the same length in the illustrated embodiments. If the two left arms 24L,27L do differ in length, the two right arms 24R,27R should differ correspondingly.

The angled pivot axes, as described herein, can be used to make the push-plate move along a path other than the as-illustrated path, which is straight, horizontal, and in line with the forks. Different paths can be engineered by changing the spacings and angles of the pivots and by changing the lengths of the arms.

The two support-pivots 25L,25R are attached to the support-plate 23, and thus are constrained to lie a fixed distance apart. The two distal-pivots 30L,30R are attached to the push-plate 29, and likewise are constrained to lie a fixed distance apart. The fixed distance apart of the support-pivots 25L,25R is the same as the fixed distance apart of the distal-pivots 30L,30R.

The arrangement of the components is such that, if the components were transparent, and were viewed in front elevation, the distal-pivots 30L,30R would appear exactly to overlie the support-pivots 25L,25R. The arrangement of the arms and pivots is symmetrical about a vertical central axis of the carriage; however, symmetry is not essential, and in some specialised applications the arrangement might not be symmetrical.

The effect of these geometric constraints is that, when the proximal-arms 24L,24R move through their arcs 26L,26R, the distal-pivots 30L,30R move along respective straight lines 32L,32R. The lines 32L,32R lie at right angles to the support-plane, i.e to the plane defined by the support-pivots 25L,25R, i.e the plane of the support-plate 23.

It is noted again that the constraints of the mechanism are such that the distal-pivots 30L,30R overlie the support-pivots 25L,25R in the front elevational view, and this is true when the arms are folded up, and when the arms are fully extended, and at all points in between.

The designer should see to it that the two support-pivots 25L,25R accurately and truly do lie in a single support-plane and the two distal-pivots 30L,30R lie in a single distal-plane; that the support-plane is parallel to the distal-plane; that the three left pivots 25L,28L,30L are all parallel (i.e are all parallel to a notional line termed the left-pivot-line), and the three right pivots 25R,28R,30R are all parallel (i.e are all parallel to a notional line termed the right-pivot-line). As mentioned, preferably, as shown, the four arms 24L,27L,24R,27R are all the same length (the length of the arm being the distance between its pivot axes, measured at right-angles to the pivot axes). Under these conditions, the straight-line motion of the distal-pivots 30L,30R (and thus of the push-plate 29) is accomplished without any stresses and strains being imposed upon the arms and the several pivots.

Any deviation from truly accurate parallelism etc will impose distortions on the arms and pivots during the push-off movements. Given that some misalignment and other errors will inevitably be present due to manufacturing tolerances, the designer should ensure that the components are physically compliant enough, or are given sufficient running clearance, to accommodate to the errors. If the errors were too large, either the components would be bent out of shape or, if the components were very strong and rigid, the mechanism would jam up.

It is recognised that the components can be made accurately enough, without resorting to special high-precision manufacturing methods, in the context of the normal methods used in the manufacture of accessories for forklift trucks, i.e that the inevitable misalignments etc can be accommodated within the compliances inherent in the structure of the components.

In some cases, the designer may prefer to have the lengths of the distal-arms different from the lengths of the proximal-arms. This might be done, for example, where the distal-pivot attachment point on the push-plate needs to be at a different height from the support-pivot attachment point on the support-plate. It is noted, again, that the three left hinges should be parallel to each other, and the three right hinges should be parallel to each other; also, the left proximal-arm should be the same length as the right proximal-arm, and the left distal-arm should be the same length as the right distal-arm; but so long as those conditions are met, the proximal-arms do not need to be the same lengths as the distal-arms.

The push-off attachment 20 will be designed to provide a push-off force, typically, of a tonne or two. Of course, the components have to be designed to accommodate the stresses and strains imposed during operation up to the maximum working loads. Given that the attachment must in any event be designed to cope with these stresses and strains, it is recognised that the stresses and strains imposed by geometrical misalignments etc, of the magnitude arising from normal truck-accessory manufacturing methods, will automatically be accommodated, without the need to resort to especially robust (expensive) structures.

FIG. 2 shows the support-plate 23 and the push-plate 29, but now the arms 24L,27L,24R,27R are shown in a more collapsed or folded state, i.e the push-plate has not been pushed out so far in FIG. 2 as it was in FIG. 1. However, in FIG. 2, the pivots still remain parallel to each other, as in FIG. 1. It is emphasised again that the distal-pivots 30L,30R move along the respective straight lines 32L,32R, throughout their range of movement.

FIG. 3 shows the support-plate and the forks 34L,34R. The forks are hooked over the top edge of the support-plate, and the forks may slide sideways along the top edge, for fine adjustment of their position. The support-plate is fastened to a suitable attachment point on the carriage of the forklift truck. (The support-plate (like the push-plate) is formed with visibility apertures, as shown, for safe operation of the truck.) The structures for mounting the support-pivots 25L,25R are shown at 35L,35R on FIG. 3.

FIG. 4 is a front elevation, which shows the left and right distal-arms 27L,27R in the fully closed together position. The support-plate 23 is not shown in FIG. 4, and the proximal-arms are not shown in FIG. 4, but it will be understood that the support-pivots 25L,25R lie over the distal-pivots 30L,30R in the front elevational projection. The push-plate 29 is shown in FIG. 4.

In FIG. 4, the left knee-pivot 28L lies at a pin-angle PA of 120° to the right knee-pivot 28R. Also, as shown, the left distal-pivot 30L lies at the same pin-angle PA of 120° to the right distal-pivot 30R. Although not shown in FIG. 4, the left support-pivot 25L lies at the same pin-angle PA of 120° to the right support-pivot 25R. The apparatus being symmetrical, the left pivots 25L,28L,30L lie each at an angle PL of +60° to the vertical, and the right pivots 25R,28R,30R each at an angle PR of −60° to the vertical.

The support-pivots 25L,25R are constrained to remain always in the same support-plane as each other during operation, since both support-pivots are integrated into the support-plate 23. Similarly, the distal-pivots 30L,30R are constrained to remain always in the same distal-plane as each other during operation, because both distal-pivots are integrated into the push-plate 29. It follows that the two knee-pivots 28L,28R also always remain in the same knee-plane as each other during operation. All three planes remain always parallel during operation, the knee-plane moving away from the support plane at half the rate the distal-plane moves away from the support-plane (given that all four arms are the same length).

It will be understood that if the load that is being pushed off the forks should not be exactly centred, for example, between the left and right areas of the push-plate, the forces experienced by the left arms and pivots might be different from the forces experienced by the right arms and pivots. Such differences in force will of course tend to cause unequal distortions and misalignments in the components, and the designer must see to it that the components are rigid enough that the resulting misalignments of the pivots are small enough that the pivots retain the characteristic of still being parallel.

It should be noted that the push-off attachment might be too flimsy, such that, when the push-off force was applied, the pivots would be distorted out of alignment to a sufficient extent that the mechanism would jam up. It is further noted that a reasonably prudent designer, upon designing the arms and pivots to be strong and rigid enough for a push-off force of one or two tonnes, will find no difficulty in designing the arms and pivots to be, at the same time, strong and rigid enough to cope with any misalignments that might arise due to the load not being centralised on the forks. That is to say: the angled-pivots mechanism as depicted herein is in keeping with the usual fabrication techniques commonly practised by manufacturers of attachments for fork-lift trucks.

FIG. 5a shows structural details of a typical pivot pin, and the associated components, as used in the depicted attachments. The arm 36 is of rectangular-tubular steel section. A pivot-tube 37 comprises a length of steel tubing, and is welded to the arm 36. Sleeves 38 of bearing material are inserted into the pivot-tube 37. Pivot-side-plates 39 are welded to the component 40 to which the arm 36 is pivoted (which may be another arm, as shown, or may be e.g the support-pivots mountings 35L,35R on the support-plate 23). The length of the open space between the pivot-side-plates 39 is a little larger than the distance over the bearing sleeves 38. A hollow pivot pin 42 is clamped immovably between the pivot-side-plates 39 by a through-bolt 43.

The designer may select another arrangement of the pivot components, noting that the ability of the pivot structure to resist distortion and misalignment is affected by (among other things) the length of the pivot pins. In fact, the important length is the length of the bearing-spread, rather than the length of the pivot pin, as such. The bearing-spread is the distance apart of the furthest-apart points actually forming the bearings, being the points that undergo actual bearing contact during rotation of the pivot bearing, being the length BS in FIG. 5a. The actual bearing contact may be rubbing contact, which is the case with the plain rubbing bearings as illustrated; or may be rolling contact, which is the case if balls or rollers were to be used in place of the plain bearings.

In the embodiment as illustrated in FIG. 5a, the bearing-spread is seven inches. That would be satisfactory for an attachment that produces a push-off movement of about sixty inches. (Sixty inches is typical of what is required to push a load off the forks of a conventional fork-lift truck.) It is recognised that the required rigidity of the attachment could not be achieved, at least not without resorting to expensive reinforcement and precision, if the bearing-spread were less than about four inches.

The arms themselves are very rigid, being of rectangular-tubular steel (the tubing being 8″×3″ in the particular case). The support-plate and the push-plate, as illustrated, are also of heavy rigid construction. Again, it is noted that the attachment as described herein is in keeping with manufacturing by conventional fabrication, using welded sheet steel forms such as plates, angles, tubes, and the like.

Although the three pivots are loaded differently, during operation, all three should have the large bearing-spread, as mentioned. The large bearing-spread is a measure of the pivot's ability to resist twisting and other abusive distortions, rather than a measure of the pivot's ability to resist wear, in this case. As may be understood from FIG. 5a, the bearing-spread is about equal to the width of the arm: i.e BS equals eight inches, more or less. A structure which, though having some similarities to the designs as depicted herein, has arms less than about four inches wide, would not be suitable for use as a push-off attachment for a fork-lift truck, as that expression is used in the context of this specification. Similarly, a structure which, though having some similarities, has pivots having a bearing-spread of less than four inches, again would not be suitable for use as a push-off attachment for a fork-lift truck.

It should be noted that many designs of conventional toggle or scissors mechanisms do not require the pivot bearings themselves to resist twisting of the arms. That is to say, in those designs, other guides are provided, besides the pivots themselves, for accommodating sideways forces, off-centre loads, and the like. Therefore, in those designs, the pivot pins could be short. Those pivot bearings did not need the large bearing-spread, as the pivot bearings do in the present design. In the present design, it is a key advantage that nothing else is needed, other than the pivots, to provide the whole guiding function; that being so, a large bearing-spread is a key factor of the present design. (If the pivot axes in the present design were replaced with ball-joints (a ball-joint being the equivalent of a bearing with a zero bearing-spread), the push-plate would not be supported and guided in the attachment—either not at all, or not properly.) The larger the bearing-spread, the more the pivot structure is constrained to resist all modes of movement other than rotation about the pivot axis, as required in the present design.

The weight of the hanging components of the attachment imposes stresses in the pivots. The geometry is such that the weight causes the load acting at one end of the pin to be in the opposite direction from the load at the other end of the pin, giving rise to a moment tending to make the pivot turn end-over-end. The pivot pins will bend under these moments, and the arms will deflect torsionally. The designer's task is to see to it that the deflections are small enough that they have no substantial effect on the operation of the attachment. Thus, the arms should be themselves of high torsional rigidity, and the deflections attributable to the pivots should be comparable with the deflections attributable to the arms. There would be little point in the pivots being very rigid if the arms were flimsy, and vice versa.

It is recognised that the attachment as depicted herein enables both the arms and the pivots to be of adequate rigidity, and yet the manner of construction that is simple and inexpensive, given normal fabrication techniques familiar to manufacturers of fork lift attachments.

It is a simple matter to make the bearing spread equal, more or less, to the width of the arm, as shown in FIG. 5a. It is not suggested that this manner of making a bearing is new per se; however, it is recognised that this simple inexpensive structure provides a bearing in which the desired mechanical properties of the bearing match the desired mechanical properties of the arm.

On the other hand, other bearing arrangements are not ruled out. FIGS. 5b and 5c show some further examples. FIG. 5a is preferred, however. If the bearing-spread were less than about ¾ of the width of the arm, in that case it would probably be true that the extra strength and rigidity of the arm were simply being wasted. The converse would be true if the bearing-spread were more than say 1½ times the width of the arm. The two arms that meet at the pivot should have both the same torsional rigidity—in that the extra rigidity of the more rigid arm would simply be wasted. For the purposes of the foregoing definition, the width of the arm is the width as measured parallel to the pivot axis, and is the smallest width of the arm if the width of the arm varies.

For minimum strain on the pivot pins, it is best for the (three) pivot pins of the left arms to be at right angles to the (three) pivot pins of the right arms. The more the angle PA differs from 90°, the greater the strain on the pins during operation of the mechanism. While a few degrees deviation from a true right angle is of no consequence, the angle PA should not be more than about 130°, and preferably not more than about 120°.

In the configuration as shown in FIG. 4, the pivot 42 axis lies at right angles to the longitudinal axis of the (rectangular) tubing that makes up the arm 36. This is the simplest manner of construction, in that the pivot-side-plates 39 are straight flat plates that are welded flat-on to the sides of the tubing. However, it is not required that a line joining the midpoints of the pivots must be at right angles to the pivot axes (although, as mentioned, it is required that the arm's two pivot axes be parallel).

FIG. 6 shows an embodiment in which the pivots 53L,54L at the ends of the left arm 56L are parallel to each other, but are not at right angles to the longitudinal line of the arm. On the other hand, the angle PA is the favoured ninety degrees. When using the pivot structure of FIG. 4, one of the aspects that needed to be addressed by the designer was to make sure the knee-pivots 28L,28R at the upper ends of the arms do not knock together when the mechanism is fully retracted. As will be understood from FIG. 4, if the angle PA were smaller, the knee-pivots would be in danger of knocking together. In FIG. 4, the axis of the pivot pin 42 lies at right angles to the line of the arm 36, and the angle PA is 120°; the width limitations of the carriage of the forklift truck inhibit the knee-joints from being spaced any further apart. In the FIG. 4 configuration, therefore, if the designer wishes to increase the length of the arms, so as to achieve a longer operational reach for the mechanism, the designer might be at some trouble to make sure the upper ends of the arms (i.e the knee-joints) do not knock together when the arms are fully folded.

This is the problem that is alleviated by off-setting the pivots at the ends of the arms in the manner as shown in FIG. 6. In FIG. 6, the arm length AL is measured at an angle to the longitudinal axis of the arm. The designer can plan the angular off-set configuration of the arms to suit the desired operational reach to be achieved by the attachment, within the constraints of width etc of the carriage. Of course, the designer must be mindful of the arcs the arms move through during operation, and should ascertain that the components do not swing outside the permitted envelope. But measures such as those shown in FIG. 6 can be resorted to, if desired.

The attachment is operated by means of hydraulic rams. FIG. 7A shows the arms 24R,27R in a folded position. FIG. 7B shows the arms in an opened-out position. It is desirable that the push force, as applied at the distal-pivot 30R, should be the same multiplication factor of the hydraulic pressure at all points of the operational movement of the ram; however, this factor inevitably does vary as the arms move out, but it is recognised that, with some attention to the position of the knee-ram-pivot 46R, the variation over the operational range or stroke can be kept reasonably small. It is preferred that the hydraulic ram 45R be housed actually within the outlines of the proximal-arm 24R, noting that the closed length of the ram should fit within the length of the proximal-arm. The tubular wall of the proximal-arm is cut away to the extent necessary to allow the ram to swing with respect the arm. Similarly, the distal-arm 27R is cut away as required.

The designer may prefer, in some cases, to mount the ram directly to the carriage, rather than on the proximal-arm. It may be arranged that the ram acts between the proximal-arm and the distal-arm (FIGS. 7A,7B), or between the carriage and the distal arm, or between the carriage and the proximal arm. The designer must of course see to it that the components accommodate the loading in each case, but the point is that the geometry of the arms arrangement does not require that the rams must always and only be set up to act from arm to arm, as shown. It will be understood also that, in FIGS. 7A,7B, alternatively the plate to the left may be the (fixed) support-plate, and the plate to the right the (moving) push-plate, as far as the geometry of the ram mountings is concerned.

The disposition of the hydraulic hoses is shown in FIG. 8. The distal-arms are omitted from FIG. 8, as are the hydraulic rams themselves. The two bottom ram-fittings 49L,49R are connected together, and are fed through a common source 50. Similarly, the two top ram-fittings 52L,52R are connected both to a common drain 54. (The drain and source are valved oppositely for movement in the opposite direction.)

There is no need for a hydraulic flow-equaliser to be provided, to equalise the rates at which fluid is supplied to the rams: if the forces on the rams should happen to be unequal, the geometry of the arms and pivots resists the tendency for one ram to move ahead of the other. It may be noted that some previous designs of push-off attachment required more hoses, and/or were such that the hoses could become trapped in the toggle-arms—whereby the descriptive “scissors” tag became all too literally true. As shown in FIG. 8, it is simple to arrange for the hoses as shown, and the supply and drain hoses, to remain tucked away, and unable to touch the moving parts, throughout the whole range of travel.

It is usually preferred that the arms and pivots be arranged such that the straight lines 32L,32R (i.e the lines along which the distal-pivots travel) lie parallel to the plane defined by the top faces of the forks, along which the load is being pushed. That is to say: the straight line along which the push-plate travels remains always the same height above the top surface of the forks. That being so, the push-plate 29 then does not have to slip vertically with respect to the load as the load moves along the forks.

1. A push-off attachment apparatus for a forklift truck having forks carried on a moveable carriage, wherein:
the attachment includes a mounting-structure and a push-plate;
the mounting-structure includes means for being mounted on the carriage;
the push-plate is structured for moving a load along the forks;
the attachment includes a guide-mechanism, which is structured for supporting and guiding the push-plate for movement towards and away from the mounting-structure;
the guide-mechanism comprises left and right proximal-arms and left and right distal-arms;
the left and right proximal-arms are pivoted to the mounting-structure at left and right mounting-pivots;
the left and right distal-arms are pivoted to the push-plate at respective left and right distal-pivots;
the left and right distal-arms are pivoted to the left and right proximal-arms at respective left and right knee-pivots;
the left pivots, being the left mounting-pivot, the left distal-pivot, and the left knee-pivot, are all parallel to a left-pivot-line;
the right pivots, being the right mounting-pivot, the right distal-pivot, and the right knee-pivot, are all parallel to a right-pivot-line; and
when viewed in a front elevation of the truck, the left-pivot-line is substantially not parallel to the right-pivot-line.

2. Apparatus of claim 1, wherein:
when viewed in a front elevation of the truck, the left-pivot-line lies at a pivot-angle PA with respect to the right-pivot-line; and
the pivot-angle PA is between 80° and 130°.

3. Apparatus of claim 2, wherein the pivot-angle PA is between 110° and 130°.

4. Apparatus of claim 1, wherein the attachment is self-contained as to supporting its own weight, in that the weight of the push-plate derives substantially no support from the forks.

5. Apparatus of claim 1, wherein the left and right support-pivots, the left and right knee-pivots, and the left and right distal-pivots, collectively termed the six pivots, include respective pivot-bearings, and the pivot-bearings all have respective bearing-spreads greater than four inches.

6. Apparatus of claim 5, wherein:
the left and right proximal-arms and the left and right distal arms are collectively termed the four arms;
in respect of the six pivots, each one is a pivot between one of the four arms and another element, where the element has a width that is not less than the width of that arm; and
the bearing-spread is more than ¾ the width of the arm.

7. Apparatus of claim 6, wherein the bearing-spread is also not more than 1½ times the width of the arm.

8. Apparatus of claim 6, wherein, in respect of all four arms, each arm has respective ones of the pivots at each end, and the arm is of such inherently stiff structure as to render the pivot at one end torsionally rigid with respect to the pivot at the other end.

9. Apparatus of claim 8, wherein the arm is of rectangular hollow-tubular form, having a width of more than four inches and a thickness of more than two inches.

10. Apparatus of claim 1, wherein:
the apparatus includes a left hydraulic ram and a right hydraulic ram; and
at least when the attachment is in a closed-together condition, the rams lie at least partially contained inside the hollow interiors of the respective arms, the tubular walls thereof being cut away appropriately to accommodate the rams.

11. Apparatus of claim 1, wherein:
a left-line joining the left support-pivot to the left distal-pivot is horizontal, and remains horizontal as the push-plate moves away from and towards the support-plate; and
the left knee-pivot lies above the left-line, and remains so as the push-plate moves away from and towards the support-plate.

12. Apparatus of claim 11, wherein, also:
a right-line joining the right support-pivot to the right distal-pivot is horizontal, and remains horizontal as the push-plate moves away from and towards the support-plate;
and
the right knee-pivot lies above the right-line, and remains so as the push-plate moves away from and towards the support-plate.

13. Apparatus of claim 1, in combination with the fork lift truck.

14. Combination of claim 13, in use to push a load off the forks.

15. Combination of claim 13, in use to pull a load onto the forks.
